(19) United States
(12) Patent Application Publication
(10) Pub. No.: US 2007/0093592 A1
(43) Pub. Date: Apr. 26, 2007

(54) Polypropylene nanocomposites

(76) Inventors: Tae Won Hwang, Daejeon (KR); Soon Joon Jung, Hwaseong-si (KR); Chi Hoon Choi, Suwon-si (KR); Jae Young Jo, Seoul (KR); Byeong Uk Nam, Cheonan-si (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/305,728

(22) Filed: Dec. 15, 2005

(30) Foreign Application Priority Data
Oct. 20, 2005 (KR) 10-2005-0099285

(51) Int. Cl. C08K 5/00

(52) U.S. Cl. 524/515

(57) ABSTRACT

The present invention relates to a polypropylene nanocomposite comprising (a) about 1 wt % to about 40 wt % of an acid- or acid anhydride-modified polypropylene; (b) about 0.1 wt % to about 50 wt % of an organically modified layered silicate; and (c) about 30 wt % to about 90 wt % of a nonpolar polypropylene, wherein the acid- or anhydride-modified polypropylene has a molecular weight that is lower than that of the nonpolar polypropylene, and wherein the polypropylene nanocomposite has a linear thermal expansion coefficient ranging from about 4×10⁻⁵/° C. to about 9×10⁻⁵/° C. The density and linear thermal expansion coefficient of these nanocomposites are, respectively, 10% to 20% and 20% to 40% less than conventional polypropylene composites and can be used to form durable molded products with superior dimensional stability, good tensile strength, good moldability, and high thermal resistance.

### CROSS REFERENCE TO RELATED APPLICATIONS

This application claims priority of Korean Patent Application No. 10-2005-0099285, filed on Oct. 20, 2005, with the Korean Intellectual Property Office, the disclosure of which is fully incorporated herein by reference.

### FIELD OF THE INVENTION

The present invention relates to polypropylene nanocomposites. More specifically, the present invention relates to polypropylene nanocomposites comprising an acid- or acid anhydride-modified polypropylene, an organically modified layered silicate, and a nonpolar polypropylene. The density and linear thermal expansion coefficient of these nanocomposites are, respectively, 10% to 20% and 20% to 40% less than conventional polypropylene composites and can be used to form durable molded products with superior dimensional stability, good tensile strength, good moldability, and high thermal resistance.

### BACKGROUND OF THE INVENTION

Polypropylene thermoplastic polymers are well known in the art. Their low average density of 0.905 g/cm and high melting point of about 165° C., together with their heat resistance, tensile and flexile strength, make them ideal for use in a variety of applications such as automotive exterior/interior components, electronics, and other molded products. Polypropylene is also highly recyclable, easily formable, and economical to produce. Depending on the tacticity of the polypropylene structure, it can adopt either an isotactic, syndiotactic, atactic form, or a combination of these, as described in U.S. Pat. No. 6,300,419.

Crystalline polypropylene, though mechanically strong, is quite susceptible to compressibility, temperature, and crystallisation shrinkage, which could range from 16/1000 to 18/1000 and therefore has a high linear thermal expansion coefficient. As such, a method of forming molded polypropylene products with a high dimensional stability without compromising its strength has been sought. One such method in the art produce polypropylene composites that are admixed and compounded with inorganic reinforcing materials, e.g. talc, glass fiber, mica. As an example, automotive exterior components are typically prepared by including about 20 wt % to 40 wt % of talc, which yields a material having a density of about 1.14-1.22 g/cm₃.

Polymer/clay nanocomposites have received some attention in this regard; even a small amount of nanodispersed organically modified layered silicate filler can achieve improved mechanical properties in the resulting composite, e.g. modulus, strength, heat resistance, heat deflection temperature, flame retardancy, and lowered permeability to gas and moisture. The mechanism underlying such enhanced properties is the greatly increased surface area provided by the small silicate particles, which in turn maximizes interfacial interaction between the polymer matrix and the organically modified layered silicate filler structure. As a result, the nanocomposite undergoes a lessened degree of dimensional change in response to temperature fluctuations.

Korean patent publication No. 1999-63337 discloses a polypropylene that is easily coated, comprising (1) 40-99 wt % of polypropylene, (2) 1-60 wt % of ethylene/α-olefin copolymer elastomer, (3) 20-50 weight parts of polypropylene resin having low molecular weight, modified with unsaturated carboxylic acid or acid anhydride, and (4) 0.1-20 weight parts epoxy resin, relative to 100 weight parts of a mixture of (1) and (2). Despite good coatability, however, this resin exhibited poor mechanical properties and ejectability in an injection molding.

Korean patent publication No. 1999-39953 discloses a coatable polypropylene composite, comprising crystalline ethylene-propylene copolymer, various ethylene-α-olefin copolymers, calcium-metha-silicate based inorganic reinforcing material, modified resin , and various additives. The composite formed, though more readily coatable, has drastically poorer mechanical properties. In light of the above, there is a need in the art for alternative methods of preparing nanocomposites that are low in density and high in dimensional stability, tensile strength, moldability, and thermal resistance

### SUMMARY OF THE INVENTION

The present invention relates to a polypropylene nanocomposite comprising
(a) about 1 wt % to about 40 wt % of an acid- or acid anhydride-modified polypropylene;
(b) about 0.1 wt % to about 50 wt % of an organically modified layered silicate; and (c) about 30 wt % to about 90 wt % of a nonpolar polypropylene, wherein the acid- or anhydride-modified polypropylene has a molecular weight that is lower than that of the nonpolar polypropylene, and wherein the polypropylene nanocomposite has a linear thermal expansion coefficient ranging from about 4×10⁻⁵/° C. to about 9×10 ⁻⁵/° C.

The density and linear thermal expansion coefficient of these nanocomposites are, respectively, 10% to 20% and 20% to 40% less than conventional polypropylene composites and can be used to form molded products with superior dimensional stability and good tensile strength.

### DETAILED DESCRIPTION OF THE PREFERRED EMBODIMENTS

The present invention relates to a polypropylene nanocomposite comprising (a) about 1 wt % to about 40 wt % of an acid- or acid anhydride-modified polypropylene; (b) about 0.1 wt % to about 50 wt % of an organically modified layered silicate; and (c) about 30 wt % to about 90 wt % of a nonpolar polypropylene, wherein the acid- or anhydride-modified polypropylene has a molecular weight that is lower than that of the nonpolar polypropylene, and wherein the polypropylene nanocomposite has a linear thermal expansion coefficient ranging from about 4×10⁻⁵/° C. to about 9×10⁻⁵/° C.

Due to the nonpolarity of polypropylene component (c), which serves as a polymer matrix, there is limited compatibility between component (c) and the organically modified layered silicate. It has been observed, however, that the use of acid- or acid anhydride-modified polypropylene can improve the intercalation and dispersion, of layered silicate in the polymer matrix. The present invention provides an improved polypropylene nanocomposite by enhancing the interfacial adhesion between the various component phases of the nanocomposite.

In one embodiment of the invention, the polypropylene nanocomposite comprises about 1 wt % to about 40 wt % of an acid- or acid anhydride-modified polypropylene. More preferably, the polypropylene nanocomposite comprises about 5 wt % to about 30 wt % of an acid- or acid anhydride-modified polypropylene. It should be noted that sufficient dispersion of layered silicate in the polypropylene matrix cannot occur to yield a nanocomposite having the properties noted above if the amount of acid- or acid anhydride-modified polypropylene used falls below 1 wt %. If the wt % of acid- or acid anhydride-modified polypropylene is too high, i.e. above about 40 wt %, a nanocomposite with sub-optimal mechanical properties such as lower impact strength will result due to decreased compatibility between the layered silicate and the nonpolar polypropylene matrix. The appropriate amount of acid- or acid anhydride-modified polypropylene can be varied accordingly by those skilled in the art to achieve the object of the present invention.

In some embodiments, the acid- or acid anhydride-modified polypropylene has an average molecular weight (MW) of about 20,000 to about 60,000, which is less than that of the nonpolar polypropylene matrix. If the MW is too low, i.e. below about 20,000, the shear stability and miscibility of the polypropylene will be reduced, which presents problems in the subsequent mixing and compounding process. On the other hand, if the MW is too high, ie. above about 60,000, the dispersion of the layered silicate between the polypropylene matrix layers becomes more difficult. The appropriate size of acid- or acid anhydride-modified polypropylene to be employed will depend on the properties desired, amongst other factors, and can be readily determined by one of skill in the art.

In some preferred embodiments, the acid- or acid anhydride-modified polypropylene has a melt viscosity of about 5,000 to about 15,000 centipoise (cP), more preferably about 5,000 to about 10,000 cP, at 190° C., as measured by a Brookfield viscometer. If the melt viscosity is below 5,000 cP, the level of miscibility may become unsuitable for the subsequent extrusion. On the other hand, a melt viscosity of above 15,000 cP will interfere with the dispersion of layered silicate into the polypropylene matrix. The appropriate melt viscosity can be determined by one of skill in the art in light of the processing conditions and the above considerations.

The preferred acid- or acid anhydride-modified polypropylene itself should comprise about 0.5 wt % to about 10.0 wt % of acid or acid anhydride (based on the weight of the acid- or acid anhydride-modified polypropylene). Too low an amount, i.e. below about 0.5 wt %, would interfere with dispersion of the organically modified layered silicate due to lowered compatibility between the silicate and the polypropylene matrix; too high an amount, i.e. above about 10.0 wt %, will result in a nanocomposite with suboptimal mechanical properties due to reduced compatibility between the acid- or acid anhydride-modified polypropylene with the nonpolar polypropylene matrix.

In some embodiments wherein an acid-modified polypropylene, as opposed to an acid anhydride-modified polypropylene, is selected for practicing the present invention, the acid is an unsaturated carboxylic acid selected from the group consisting of maleic acid, acrylic acid, methacrylic acid, fumaric acid, itaconic acid and crotonic acid, or mixtures thereof. In other embodiments, wherein an acid anhydride-modified polypropylene is selected, the acid anhydride is an anhydride derived from a member of the aforementioned group.

While any polypropylene polymer that is susceptible to acid or acid anhydride modification can theoretically be used to achieve the object of the present invention, it is preferably a member selected from the group consisting of propylene homopolymer, propylene/ethylene random copolymer, propylene/ethylene block copolymer, ethylene/propylene/ÿ-olefin terpolymer, and mixtures thereof. The acid- or acid anhydride-modified polypropylene having low molecular weight modified with acid or acid anhydride may be prepared according to any grafting reaction in melt extrusion or solution processing methods known in the art.

In some embodiments of the invention, the organically modified layered silicate is preferably a clay having an interlayer or interlaminar distance of 15-60 Å. Too small an interlayer distance, i.e. below about 15 Å, will make dispersion more difficult and permit less incorporation of acid- or acid anhydride-modified polypropylene. In contrast, if the interlayer distance is too great, ie. above about 60 Å, the silicate sheet structure may not be maintained, resulting in waste and a nanocomposite with poorer mechanical properties. An excessively large interlayer distance also increases the chance that foreign organic materials become introduced, ultimately resulting in the emission of undesirable odors.

A number of organically modified layered silicates, e.g. montmorillonite, bentonite, etc., can be used to achieve the object of the present invention. Preferably, the organically modified layered silicate selected is an organically modified montmorillonite. Montmorillonite is a clay with a structure characterized by silicate tetrahedral sheets and alumina octahedral sheets in a 2:1 ratio.

In an organically modified layered silicate, interlayer metal cations are replaced with organic molecules to improve the silicate's compatibility with the acid-or acid anhydride-modified polypropylene. In some embodiments of the present invention, the layered silicate is preferably organically modified with an organic cation, most preferably an amine salt. The amine salt may be selected from one of the group consisting of stearyl ammonium, dimethyl dehydrogenated tallow ammonium, sodium dodesyl ammonium, and dimethyl dibehenyl ammonium. Examples of organically modified layered silicate that are commercially available include products from the Cloisite® series (Southern Clay Corp.).

To exert finer control over the properties of the polypropylene nanocomposite formed, it may be important to determine the properties of the acid- or acid anhydride-modified polypropylene and the organically modified layered silicate. Further, the method by which these materials are processed may also be important in controlling the characteristics of the polypropylene nanocomposite of the present invention.

The greater the amount of organically modified layered silicate in the polypropylene nanocomposite, the better the flexural modulus, tensile strength, and linear thermal expansion coefficient compared to conventional composites with dispersed phase morphology.

The nanoscopic dispersed phase in the nanocomposite effectively increases the interfacial adhesion between the nonpolar polypropylene matrix and the organically modified layered silicate, thereby improving dimensional stability and various other mechanical properties, e.g. lower density, greater tensile, etc., despite the use of less filler. In the composite of the present invention, the organically modified layered silicate is the dispersed phase, i.e. it is dispersed in the nonpolar polypropylene matrix, and the acid- or acid anhydride-modified polypropylene acts as a compatibilising agent.

In some embodiments of the present invention, the acid- or acid anhydride-modified polypropylene and organically modified layered silicate are melt compounded in an extruder in a continuous process to provide a master batch, which is further admixed with nonpolar polypropylene. The nonpolar polypropylene, which acts as a polymer matrix, has a higher molecular weight and better mechanical properties than the acid- or acid anhydride-modified polypropylene. Melt compounding of the acid- or acid anhydride-modified polypropylene and organically modified layered silicate can alternatively be done using a variety of devices and/or methods known in the art. Preferably, the melt compounding is done in a twin-screw extruder.

In some embodiments, the nonpolar polypropylene may be one selected from the group consisting of crystalline propylene homopolymer, propylene/ethylene random copolymer, propylene/ethylene block copolymer, ethylene/propylene/α-olefin terpolymer, and mixtures thereof. The nonpolar polypropylene should have an average molecular weight of about 80,000 to about 500,000. Too low a molecular weight, i.e. below about 80,000 would lead to poor mechanical properties. Too high a molecular weight, however, i.e. above about 500,000, will result in higher viscosity, which in turn decreases moldability. Though the molecular weight can be varied by one of skill in the art based on processing conditions and other factors, the nonpolar polypropylene should have a greater molecular weight than the acid- or acid anhydride-modified polypropylene.

In some embodiments, the polypropylene nanocomposite comprises about 30 wt % to about 90 wt % of nonpolar polypropylene. Too little an amount, i.e. below about 30 wt %, leads to decreased elasticity and impact strength in the resulting nanocomposite despite an improvement in tensile and flexural strength and modulus. In contrast, too great an amount, i.e. above about 90 wt %, makes the dispersion of organically modified layered silicate in the polypropylene matrix difficult.

Though not necessary to achieve the object of the present invention, the nonpolar polypropylene should preferably have a melt index of about 0.5 g/10 min to about 100 g/10 min. The polypropylene nanocomposite, prepared according to the method(s) set forth above, should exhibit low shrinkage with a linear thermal expansion coefficient of about 4×10⁻⁵/° C. to about 9×10⁻⁵/° C., high strength, good moldability, high thermal resistance, and flame retardancy.

The polypropylene nancomposite of the present invention may optionally include an elastomeric ethylene-based copolymer. If included, between 0 wt parts to about 50 wt parts of the elastomeric ethylene-based copolymer should be used for every 100 wt parts of nanocomposite. Too high an amount of elastomeric ethylene-based copolymer, i.e. above about 50 wt parts, will result in poorer mechanical properties such as lowered heat resistance and flexural modulus.

The elastomeric ethylene-based copolymer preferably comprises about 40 wt % to about 90 wt %, more preferably about 50 wt % to about −85 wt %, of ethylene and has a Mooney viscosity , of about 10 ML₁₊₄ to about 100 ML₁₊₄ at 100° C. More preferably, it has a viscosity of about 15 ML ₁₊₄ to about 70 ML₁₊₄ at 100° C.

Exemplary elastomeric ethylene-based copolymers include elastomeric ethylene/α-olefin copolymer or elastomeric ethylene/α-olefin/diene terpolymer. In some embodiments of the present invention, the α-olefin may be selected from one of the group consisting of propylene, 1-butene, 1-hexene, 1-octene, and mixtures thereof. The diene may be selected from one of the group consisting of dicyclopentadiene, 1,4-hexadiene, dicyclooctadiene, methylene-nobodene, ethylidene-nobodene, and mixtures thereof. The appropriate elastomeric ethylene-based copolymer can be selected by those of skill in the art to precisely modulate the properties of the nanocomposite as desired.

Additional components that can be included in the polypropylene nanocomposite of the present invention, are without limitation thermal stabilizing agents, UV absorbers, hindered amine light stabilizers, antioxidants, various pigments, e.g. special effects pigments, coloring agents, lubricants, and other conventional additives.

The polypropylene nanocomposite may be prepared using any of a variety of conventional mixing and compounding devices known in the art, e.g. Banbury® mixers, Brabender® mixers, kneaders, or extruders. The twin-screw extruder is however preferred in commercial continuous processes. The temperature of the organically modified layered silicate/acid- or acid anhydride-modified polypropylene blend, the length of the extruder, residence time of the composition in the extruder and the design of the extruder (single screw, twin screw, number of flights per unit length, channel depth, flight clearance, mixing zone, etc.) are several variables which control the amount of shear to be applied to the concentrate composition for exfoliation, prior to admixing with the nonpolar polypropylene matrix. In the examples presented below, the twin-screw extruder, ZSK-25Φ and ZSK-40Φ (W&P, Germany) was used to prepare the nanocomposite in pellet form. The formation of nano morphology was ascertained by observing whether initial peaks of the organically modified silicate disappear as 2θ values varies from 1.5° to 10°.

The nanocomposite, in pellet form or otherwise, can undergo additional processing to yield various molded products using a variety of methods known in the art. Exemplary processing methods include thermoforming, extrusion, injection molding, and compression molding. The appropriate processing method to employ will depend on the characteristic of molded product desired. For example, the polypropylene nanocomposite of the present invention can be injection molded into automobile exterior parts such as, but not limited to, body side moldings, claddings, ground effects, mirror housings, spoilers, interior/exterior door handles, and A,B,C, pillars on the interior. The polymer compositions can also be injection molded into non-automotive molded products such as, but not limited to, hoods for lawn equipment and snowmobiles, fenders for motorcycles and all terrain vehicles (ATV). The polypropylene nanocomposite resin of the present invention has mechanical properties that are about 20-30% better than those of conventional polypropylene composite of comparable density and dispersed phase morphology. In particular, the present invention provides a polypropylene nanocomposite with significantly improved dimensional stability, as shown by the approximately 30% decreased inlinear thermal expansion coefficient.

Additionally, the products prepared using the polypropylene nanocomposite of the present invention has superior coatability with melamine, urethane, or acrylic paint after water washing and air drying. The lower linear thermal expansion coefficient, i.e. lower thermal shrinkage, has an advantage of avoiding separation of coating layer from the substrate.

Although the polypropylene nanocomposite produced according to the present invention is a crystalline polymer, its linear thermal expansion coefficient (about 5×10⁻⁵/° C. to 8×10⁻⁵/° C.) is similar to that of amorphous polymers such as typical polycarbonate alloys. Therefore, the polypropylene nanocomposite of the present invention has the advantages of crystalline polymers, but with remarkably improved dimensional stability. This material can thus be used to produce light-weight, durable, thermal resistant, flame retardant, and easily formable components that are suitable for a wide range of applications, such as micro-electromechanical systems, micro-optical electromechanical systems, and automotive purposes.

The following examples are provided by way of illustration only and not by way of limitation. Those of skill in the art will readily recognize a variety of non-critical parameters that could be changed or modified to yield essentially similar results.

### EXAMPLES

### Summary of Referential Examples 1-3

Pellet-shaped master batch was prepared by mixing and extruding polypropylene with an average molecular weight of 49,000 and maleic anhydride content of 2.6 wt % (Maleic anhydride Grafted Polypropylene, MAPP) and organically modified layered silicate (Southern Clay Corp., Cloisite 20A) in weight ratios of 60/40 Referential Example 1), 50/50 (Referential Example 2) and 40/60 (Referential Example 3) in a twin-screw extruder (ZSK-25Φ) at the temperature gradient of about 140-190° C.

The nano dispersed phase was observed, and the results are provided in TABLE 1 below.

TABLE 1

| | Composition | Ref. Ex. 1 | Ref. Ex. 2 | Ref. Ex. 3 |
|---|---|---|---|---|
| Contents | MAPP | 60 | 50 | 40 |
| (wt %) | | | | |
| | Organically | 40 | 50 | 60 |
| | modified layered | | | |
| | silicate | | | |
| Contents⁽¹⁾ | Antioxidants⁽²⁾ | 0.2 | 0.2 | 0.2 |
| (weight parts) | | | | |
| Mechanical | Nano dispersed | Good | Good | Unstable |
| property | phase | | | |

With regard to 100 weight parts of the MAPP and organically modified layered silicate 21 B Songwon Industry (Korea)

Based on the data provided in TABLE 1, it is observed that less dispersed phase morphology is obtained with decreased MAPP content in the master batch.

The results confirmd that nano dispersion becomes more difficult as the content of MAPP in the composition in the master batch decreases. Here, the nano dispersion was confirmed by means of X-ray diffraction (“XRD”) analysis by observing the presence of peaks at 3.8° and 7.3° of Cloisite 20A.

### Referential Example 1

Pellet-shaped master batch (MB) was prepared by mixing and extruding polypropylene with an average molecular weight of 49,000 and maleic anhydride content of 2.6 wt % MAPP and organically modified layered silicate (Southern Clay Corp., Cloisite 20A) in a weight ratio of 70/30 in a twin-screw extruder (ZSK-25Φ) at the temperature gradient of 140-190° C.

The polypropylene nanocomposite was prepared by blending the master batch and block polypropylene (B-PP), as the polymer matrix, in a weight ratio of 33/67 with the twin-screw extruder at a temperature of 180-220° C.

### Referential Example 2

The same procedure with Example 1 was carried with the exception that the weight ratios of MAPP to organically modified layered silicate and MB to polymer matrix B-PP are modified as follows:
MAPP/Cloisite 20A=60/40
MB/B-PP=25/75

### Referential Example 3

The same procedure with Example 1 was carried with the exception that the weight ratios of MAPP to organically modified layered silicate and MB to polymer matrix B-PP are adjusted as follows. Comparing these numbers with those of the previous referential examples, note how the content of organically modified layered silicate in the resulting nanocomposite is maintained at about 10 wt % in Referential Examples 1 through 3.
MAPP/B-PP/Cloisite 20A=60/10/30
MB/B-PP=33/67

### Comparative Example 1

Conventional polypropylene composite having micro-sized dispersed phase was prepared by melt compounding block polypropylene (melt index: 20 g/10 min) with 7% of talc using a twin-screw extruder at a temperature gradient of 180-220° C.

A comparison of the properties of conventional polypropylene composite formed in this manner with the properties of polypropylene nanocomposites of Referential Examples 1-3 is provided in TABLE 2 below.

### Experimental Example 1

ASTM-compliant specimens were prepared using the pellets of Referential Examples 1-3 and Comparative Example 1 with an injection molding machine Promax 150, Dongshin Hydraulics, Korea) at an injection temperature of 210-230° C. and a molding temperature of 30° C. Various mechanical properties, i.e. density, melt index, tensile strength, flexural modulus, impact strength, and linear thermal expansion coefficient, were measured; the results are provided in TABLE 2 below.

Density, melt index, tensile strength, flexural modulus, and impact strength were measured according to ASTM D792, ASTM D1238, ASTM D638, ASTM D790 and ASTM D256. The linear thermal expansion coefficient was measured by a dilatometer at temperatures ranging from about -30° C. to 80° C.

TABLE 2

| | Composition | Example 1 | Example 2 | Example 3 | Comp. Ex. 1 |
|---|---|---|---|---|---|
| Contents | MAPP | 23.1 | 15.0 | 19.8 | — |
| (wt %) | | | | | |
| | Organic modified layered silicate | 10.0 | 10.0 | 10.0 | — |
| | Block polypropylene | 66.9 | 75.0 | 70.2 | 93.0 |
| Contents⁽¹⁾ | Talc | — | — | — | 7.0 |
| (weight parts) | | | | | |
| | Antioxidant⁽²⁾ | 0.15 | 0.15 | 0.15 | 0.15 |
| Mechanical | Density | 0.94 | 0.94 | 0.94 | 0.94 |
| properties | | | | | |
| | Melt index (g/10ÿ) | 4.5 | 6.6 | 4.2 | 22 |
| | Tensile strength (kg/cm²) | 333 | 291 | 327 | 255 |
| | Flexural modulus (kg/cm²) | 22,800 | 20,700 | 21,900 | 17,000 |
| | Impact strength (kgcm/cm) | 4.2 | 4.1 | 3.6 | 7.5 |
| | Linear thermal expansion coefficient | 6.2 | 8.8 | 7.0 | 11.2 |
| | (×10⁻⁵/° C.) | | | | |

With regard to 100 weight parts of the MAPP, block polypropylene and organically modified layered silicate 21B, Songwon Industry (Korea)

As shown in TABLE 2, even at the same amount of organically modified layered silicate, increased MAPP content in master batch may cause (i) improved mechanical properties due to smaller nano morphology, (ii) increased dimensional stability and less linear thermal expansion coefficient because of lowered void between polypropylene resin and organically modified layered silicate, and (iii) decreased melt index due to the dispersion of nano particles and the resultant viscosity increase.

Polypropylene nanocomposite was prepared with a twin-screw extruder using the same ingredients under essentially the same conditions Example 1. The contents are provided in TABLE 3 below.

TABLE 3

| | | Example 2 | Example 4 | Comp. Ex. 2 |
|---|---|---|---|---|
| Contents | Ref. Ex. 1 material | 25 | — | — |
| (wt%) | | | | |
| | Ref. Ex. 2 material | — | 20 | — |
| | Ref. Ex. 3 material | — | — | 16.7 |
| | Block polypropylene | 75 | 80 | 83.3 |
| | MAPP | 15.0 | 10.0 | 6.7 |
| Mechanical | Melt index (g/10 min) | 6.6 | 11.0 | 14.2 |
| properties | | | | |
| | Tensile strength (kg/cm²) | 291 | 278 | 245 |
| | Impact strength (kgcm/cm) | 4.1 | 4.5 | 4.5 |
| | Linear thermal expansion coefficient | 8.8 | 9.4 | 10.5 |
| | (×10⁻⁵/° C.) | | | |
| | Nano dispersed phase | Good | Good | Unstable |

TABLE 3 shows how the change in MAPP content affects the morphology and mechanical properties when the amount of organically modified layered silicate is held constant. It appears that a decrease in MAPP content increases stability in the dispersed phase morphology, melt index, and linear thermal expansion coefficient, and decreases tensile strength.

### Examples 5-6 & Comparative Examples 3-5

Polypropylene nanocomposite was prepared with a twin-screw extruder using the same ingredients under essentially the same conditions as Example 1. The contents are provided in TABLE 4 below.

TABLE 4

| | | Examples | | | Comp. Ex. | | |
|---|---|---|---|---|---|---|---|
| | | 4 | 5 | 6 | 3 | 4 | 5 |
| Contents | Ref. Ex. 2 | 20 | 40 | 54 | — | — | — |
| (wt %) | | | | | | | |
| | Block polypropylene | 80 | 60 | 46 | 93.7 | 87.4 | 83.0 |
| | Talc | — | — | — | 6.3 | 12.6 | 17.0 |
| Contents⁽¹⁾ | Antioxidant⁽²⁾ | 0.2 | 0.2 | 0.2 | 0.2 | 0.2 | 0.2 |
| (weight parts)⁾ | | | | | | | |
| Mechanical | Density | 0.94 | 0.99 | 1.01 | 0.94 | 0.99 | 1.01 |
| properties | | | | | | | |
| | Melt index (g/10 min) | 11.0 | 0.85 | 0.05 | 21.0 | 22.0 | 21.5 |
| | Tensile strength (kg/cm²) | 275 | 290 | 295 | 250 | 258 | 265 |
| | Flexural modulus (kg/cm²) | 20,200 | 29,500 | 38,000 | 16,500 | 20,800 | 27,600 |
| | Impact strength (kgcm/cm) | 4.5 | 3.5 | 2.7 | 7.5 | 6.5 | 6.0 |
| | Linear thermal expansion coefficient | 8.8 | 6.0 | 4.5 | 11.2 | 10.0 | 9.2 |
| | (×10⁻⁵/° C.) | | | | | | |

With regard to 100 weight parts of the MAPP, block polypropylene, organically modified layered silicate and talc 21B, Songwon Industry (Korea)

TABLE 4 shows how the linear thermal expansion coefficient and other mechanical properties vary with the amount of organically modified layered silicate.

Comparative Examples 3-5 provide polypropylene composites having the same density as Examples 4-6, respectively. The amounts of talc was determined by considering that the content of inorganic material in the organically modified silicate is 63 wt %.

As compared with conventional talc-reinforced polypropylene composites, the polypropylene nanocomposite of the present invention has a higher flexural modulus and lower linear thermal expansion coefficient by more than 40%. Further, as the amount of the organically modified layered silicate increases, the melt index decreases drastically, which minimizes or altogether avoids the shear thinning phenomenon during the injection molding process.

### Examples 7-9 & Comparative Examples 6-8

Polypropylene nanocomposite was prepared using the master batch of Comparative Example 2, as set forth in Example 1, and adjusting the amount of polyolefin based elastomer ENGAGE8842 (Dupont Daw Elastomer Corp., Melt index =1.0 g/10 min, density=0.857 g/cm². Mechanical properties, such as density, tensile strength, flexural modulus, impact strength, and linear thermal expansion coefficient were measured and are provided in TABLE 5 below.

TABLE 5

| | | Examples | | | Comp. Ex. | | |
|---|---|---|---|---|---|---|---|
| | | 7 | 8 | 9 | 6 | 7 | 8 |
| Contents | Ref. Ex 2 | 30 | 30 | 30 | — | — | — |
| (wt %) | | | | | | | |
| | Block polypropylene | 60 | 50 | 40 | 80.5 | 70.5 | 60.5 |
| | Talc | — | — | — | 9.5 | 9.5 | 9.5 |
| Contents⁽¹⁾ | ENGAGE8842 | 10 | 20 | 30 | 10.0 | 20.0 | 30.0 |
| (weight parts)⁾ | | | | | | | |
| | Antioxidants⁽²⁾ | 0.2 | 0.2 | 0.2 | 0.2 | 0.2 | 0.2 |
| Mechanical | Density | 0.96 | 0.95 | 0.95 | 0.96 | 0.95 | 0.95 |
| properties | | | | | | | |
| | Tensile strength (kg/cm²) | 245 | 205 | 160 | 195 | 170 | 145 |
| | Flexural modulus (kg/cm²) | 20,500 | 16,000 | 13,000 | 16,000 | 13,000 | 9,500 |
| | Impact strength (kgcm/cm) | 7.0 | 13.0 | NB⁽³⁾ | 15 | 35 | NB |
| | Linear thermal expansion coefficient | 6.3 | 4.2 | 2.3 | 10.2 | 8.3 | 6.7 |
| | (×10⁻⁵/° C.) | | | | | | |

With regard to 100 weight parts of the MAPP, block polypropylene, organically modified layered silicate and talc 21B, Songwon Industry (Korea) No Break

TABLE 5 shows the relationship between the mechanical properties of the nanocomposite produced and the amount of elastomeric ethylene-based copolymer comprised therein. Note that the nanocomposites prepared in Examples 7-9 and Comparative Examples 6-8 have the same density. As indicated by the results, the linear thermal expansion coefficient decreases with increasing amounts of ethylene-based copolymer.

Those skilled in the art will appreciate that the conceptions and specific embodiments disclosed in the foregoing description may be readily utilized as a basis for modifying or designing other embodiments for carrying out the same purposes of the present. invention. Those skilled in the art will also appreciate that such equivalent embodiments do not depart from the spirit and scope of the invention as set forth herein.

What is claimed is:

1. A polypropylene nanocomposite comprising:
(a) about 1 wt % to about 40 wt % of an acid- or acid anhydride-modified polypropylene;
(b) about 0.1 wt % to about 50 wt % of an organically modified layered silicate; and
(c) about 30 wt % to about 90 wt % of a nonpolar polypropylene, wherein the acid- or anhydride-modified polypropylene has a molecular weight that is lower than that of the nonpolar polypropylene, and wherein the polypropylene nanocomposite has a linear thermal expansion coefficient ranging from about 4×10⁻⁵/° C. to about 9×10⁻⁵/° C.

2. The nanocomposite of claim 1, wherein the acid- or acid anhydride-modified polypropylene has an average molecular weight of about 20,000 to about 60,000.

3. The nanocomposite of claim 1, wherein the acid- or acid anhydride-modified polypropylene has a melt viscosity ranging from about 5,000 cP to about 15,000 cP at 190° C.

4. The nanocomposite of claim 1, wherein the acid- or acid anhydride-modified polypropylene comprises about 0.5 wt % to about 10.0 wt % of an acid or acid anhydride.

5. The nanocomposite of claim 1, wherein the acid is an unsaturated carboxylic acid selected from the group consisting of maleic acid, acrylic acid, methacrylic acid, fumaric acid, itaconic acid, crotonic acid, and mixtures thereof.

6. The nanocomposite of claim 1, wherein the acid anhydride is an anhydride derived from the acid of claim 5.

7. The nanocomposite of claim 1, wherein the acid- or acid anhydride-modified polypropylene is one selected from the group consisting of propylene homopolymer, propylene/ethylene random copolymer, propylene/ethylene block copolymer, ethylene/propylene/α-olefin terpolymer, and mixtures thereof.

8. The nanocomposite of claim 1, wherein the organically modified layered silicate has an interlayer distance ranging from about 15 Å to about 60 Å.

9. The nanocomposite of claim 1, wherein the organically modified layered silicate comprises an organically modified montmorillonite.

10. The nanocomposite of claim 1, wherein the organically modified layered silicate is organically modified with an organic amine salt.

11. The nanocomposite of claim 10, wherein the organic amine salt is one selected from the group consisting of stearyl ammonium, dimethyl dehydrogenated tallow ammonium, sodium dodesyl ammonium, and dimethyl dibehenyl ammonium, and mixtures thereof.

12. The nanocomposite of claim 1, wherein the nonpolar polypropylene has an average molecular weight ranging from about 80,000 to about 500,000.

13. The nanocomposite of claim 1, wherein the nonpolar polypropylene has a melt index ranging from about 0.5 g/10 min. to about 100 g/10 min.

14. The nanocomposite of claim 1, wherein the nonpolar polypropylene is one selected from the group consisting of crystalline propylene homopolymer, propylene/ethylene random copolymer, propylene/ethylene block copolymer, ethylene/propylene/α-olefin terpolymer and mixtures thereof.

15. The nanocomposite of claim 1, further comprising about 0 weight parts to about 50 weight parts of an elastomeric ethylene-based copolymer.

16. The nanocomposite of claim 15, wherein the ethylene-based copolymer has a Mooney viscosity ranging from about 10 ML₁₊₄ to about 100 ML₁₊₄ at 100° C. and comprises about 40 wt % to about 90 wt % of ethylene.

17. The nanocomposite of claim 15, wherein the ethylene-based copolymer is an ethylene/α-olefin copolymer or ethylene/α-olefin/diene terpolymer.

18. The nanocomposite of claim 17, wherein the α-olefin is one selected from the group consisting of propylene, 1-butene, 1-hexene, 1-octene, and mixtures thereof.

19. The nanocomposite of claim 17, wherein the diene is one selected from the group consisting of dicyclopentadiene, 1,4-hexadiene, dicyclooctadiene, methylene-nobodene, ethylidene-nobodene, and mixtures thereof.
